(19) United States
(12) Patent Application Publication
(10) Pub. No.: US 2009/0015495 A1
(43) Pub. Date: Jan. 15, 2009

(54) Automotive Antenna Apparatus and Method for Connecting Antenna Element to Cable

(75) Inventor: Norio Yoshie, Aichi-ken (JP)

Correspondence Address: MILLS & ONELLO LLP, ELEVEN BEACON STREET, SUITE 605, BOSTON, MA, 02108, US

(73) Assignee: KOJIMA PRESS INDUSTRY CO., LTD., Aichi-ken (JP)

(21) Appl. No.: 12/142,319

(22) Filed: Jun. 19, 2008

(30) Foreign Application Priority Data
Jul. 10, 2007 (JP) 2007-180573

(51) Int. Cl. H01Q 1/32

(52) U.S. Cl. 343/713

(57) ABSTRACT

The present invention improves the workability in installation work for an antenna element which is disposed in an interior space of an automotive exterior accessory. A joint 34, connecting an antenna element 24 and a ground conductor 26 to a cable 32, includes an element relay conductor 42 connected to an inner conductor of the cable 32 and a ground relay conductor 44 connected to an external conductor of the cable 32. First, a worker puts the antenna element 24 and the ground conductor 26 via an opening 22 into an interior space of a roof spoiler 18 and fixes them to pre-designated positions. Then, the worker places the joint 34 between the antenna element 24 and the ground conductor 26 and inserts edges of the joint 34 into a grip portion 36 of the antenna element 24 and a grip portion 38 of the ground conductor 26. When the insertion of the joint 34 is accomplished, the element relay conductor 42 can be held by the grip portion 36 of the antenna element 24 and the ground relay conductor 44 can be held by the grip portion 38 of the ground conductor 26. Thus, workers can smoothly finish the installation work of the antenna element without causing any interference with the cable.

### PRIORITY INFORMATION

This application claims priority to Japanese Patent Application No. 2007-180573, filed on Jul. 10, 2007, which is incorporated herein by reference in its entirety.

### BACKGROUND OF THE INVENTION

1. Field of the Invention

The present invention relates to an antenna apparatus for an automotive vehicle, and more particularly to an automotive antenna apparatus including an antenna element positioned in an interior space of an automotive exterior accessory.

2. Description of the Related Art

Aerodynamic accessories, such as spoilers and wings, are well-known external accessories attached to a vehicle body. Various electronic systems equipped in an automotive vehicle enable a driver and passengers to receive information from external devices. The systems installed on an automotive vehicle include an ordinary AM/FM radio, a television, an automotive telephone (cellular type or any other mobile telephone), as well as an intelligent device serving as a source for providing various information including road/traffic information and amusement/eating facilities information. To receive information from external devices, an automotive vehicle requires dedicated antenna apparatuses for respective systems. From an aspect of vehicle design, the layout of these antenna apparatuses is an essential factor in determining the appearance or the styling of an automotive vehicle.

To solve this problem, as discussed in Japanese Patent Application Laid-Open No. 2003-309412, antenna elements of antenna apparatuses can be housed into automotive exterior accessories. The antenna elements incorporated in automotive exterior accessories are electrically connected via cables to transmission/reception circuits provided inside a vehicle body.

In general, the interior spaces of automotive exterior accessories are limited. The work for installing an antenna element into such a narrow space is difficult for workers. In particular, if a cable is attached to an antenna element beforehand, the installation work for the antenna element becomes very complicated, and the workability deteriorates. The cables may be damaged or lowered in performances due to complexity in installing antennal elements into automotive exterior accessories.

### SUMMARY OF THE INVENTION

The present invention improves the workability in work for installing an antenna element into an interior space of an automotive exterior accessory.

According to an aspect of the present invention, an automotive antenna apparatus includes an antenna element positioned in an interior space of an automotive exterior accessory. The antenna element includes a grip portion. The grip portion is configured to hold a joint integrated with a cable electrically connected to a transmission/reception circuit and connect the antenna element to the cable. The joint includes a relay conductor electrically connected to a conductor of the cable and a joint base holding the relay conductor. When the joint is inserted into the grip portion of the antenna element, the relay conductor is brought into contact with the antenna element. Thus, the antenna element is electrically connected via the relay conductor to the cable.

According to an embodiment of the present invention, both an antenna element and a ground conductor may be positioned in the interior space of the automotive exterior accessory. In this case, the ground conductor includes a grip portion. The cable includes a first conductor and a second conductor which are insulated from each other. The joint includes a first relay conductor integrated with the first conductor of the cable and a second relay conductor integrated with the second conductor of the cable. The first and second relay conductors are held on a common joint base in an insulated manner. Namely, the joint is an assembly of two relay conductors and a common joint base. When a worker engages the joint with the grip portions of the antenna element and the ground conductor, the antenna element is brought into contact with the first relay conductor and the ground conductor is brought into contact with the second relay conductor.

In an embodiment of the present invention, the antenna element and the ground conductor can be disposed next to each other. The joint can be positioned between the antenna element and the ground conductor.

Furthermore, a contact portion where the conductor of the cable contacts the relay conductor and an uncovered portion of the conductor extending from the contact portion can be sealed with a resin or another insulating material. If the joint includes the first and second relay conductors, a resin or another insulating material can be used to integrally seal the first and second relay conductors.

Another aspect of the present invention provides a method for connecting an antenna element with a cable, which includes the steps of disposing an antenna element with a grip portion into an interior space of an automotive exterior accessory, and inserting a joint including a relay conductor electrically connected to a conductor of the cable into the grip portion of the antenna element thereby bringing the grip portion into contact with the relay conductor and electrically connecting the antenna element to the cable.

In an embodiment of the present invention, both an antenna element and a ground conductor can be positioned in an interior space of an automotive exterior accessory. In this case, the method includes the steps of disposing both an antenna element with a grip portion and a ground conductor with a grip portion into an interior space of the automotive exterior accessory, putting a joint including a first relay conductor electrically connected to a first conductor of the cable and a second relay conductor electrically connected to a second conductor of the cable into the interior space of the automotive exterior accessory, and engaging the joint with the grip portions of the antenna element and the ground conductor thereby bringing the grip portion of the antenna element into contact with the first relay conductor and bringing the grip portion of the ground conductor into contact with the second relay conductor.

In an embodiment of the present invention, the antenna element and the ground conductor can be disposed next to each other so that their grip portions are opposed to each other. In this case, the joint can be placed between the opposed grip portions of the antenna element and the ground conductor.

### BRIEF DESCRIPTION OF THE DRAWINGS

The accompanying drawings, which are incorporated in and constitute a part of the specification, illustrate a preferred embodiment of the invention and, together with the description, serve to explain the principles of the invention, in which:

FIG. 1 illustrates a roof spoiler attached to a vehicle body;

FIG. 2 illustrates an antenna apparatus including an antenna element disposed in an interior space of the roof spoiler;

FIG. 3 illustrates a detailed structure of a joint;

FIG. 4 illustrates a detailed structure of a joint base;

FIG. 5 illustrates a detailed structure of an antenna element and a ground conductor which are united with a band;

FIG. 6 illustrates an installation work for the antenna element, the ground conductor, and the joint; and

FIG. 7 illustrates a detailed structure of another joint.

### DESCRIPTION OF PREFERRED EMBODIMENT

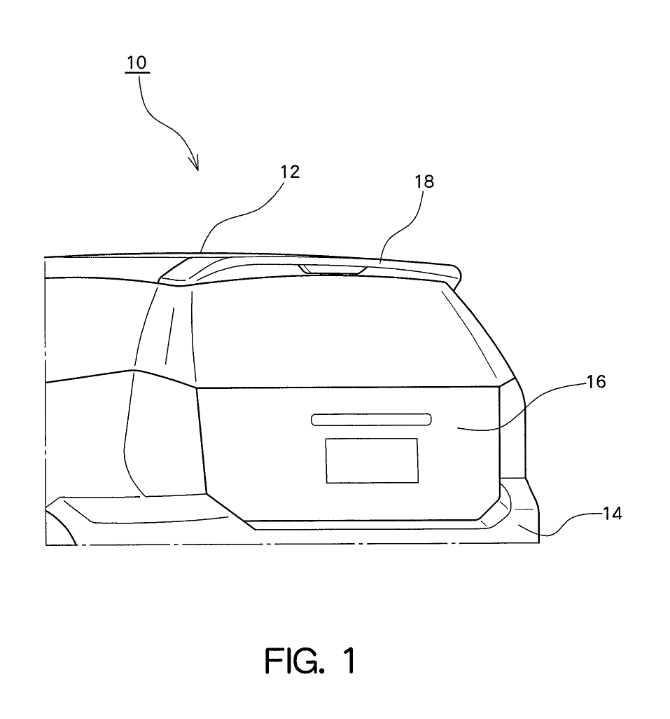

Embodiments of the present invention are described below with reference to the drawings. FIG. 1 illustrates a rear appearance of an automotive vehicle 10 equipped with aerodynamic accessories (i.e., automotive exterior accessories). The automotive vehicle 10 has a unique body shape generally referred to a “mini van” which is characterized by a trunk compartment and a passenger compartment integrated together without providing any partition between them. The automotive vehicle 10 includes a roof 12, a bumper 14, and a hatch gate 16 hinged at the rear end of the roof 12 to open and close a rear opening of the vehicle body extending from the roof 12 to the bumper 14. A roof spoiler 18 is an example aerodynamic accessory according to an embodiment of the present invention. The roof spoiler 18 protrudes rearward from the rear end of the roof 12. The roof spoiler 18 has a lateral width substantially identical to that of the roof 12. The roof spoiler 18 has a function of smoothly guiding the air stream along the surface of the roof 12. The roof spoiler 18 is an elongated plate member which is thin in the height direction and long in the width direction (lateral direction) of the vehicle.

According to an exemplary embodiment of the present invention, an antenna apparatus is provided in a roof spoiler (one of various automotive exterior accessories). According to another exemplary embodiment of the present invention, an antenna apparatus may be provided in other automotive exterior accessories, such as a trunk lid spoiler, a wing, and a stay supporting the wing.

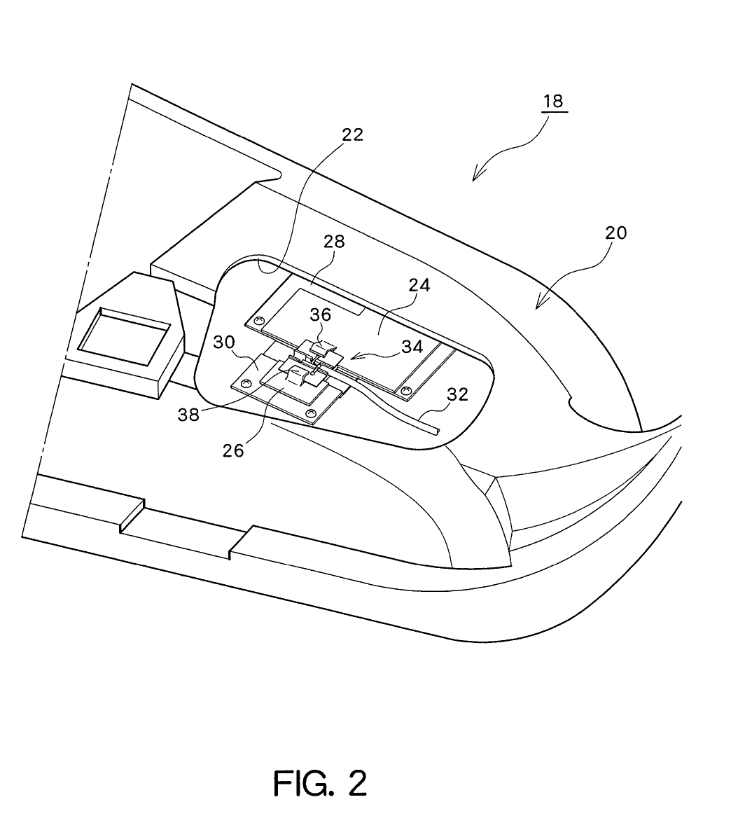

FIG. 2 illustrates an enlarged view of the roof spoiler 18. A structural member 20 has an external shape defining an appearance of the roof spoiler 18 and includes an opening 22 via which a worker can install antenna parts into an interior space of the roof spoiler 18. As illustrated in FIG. 2, the opening 22 allows a worker to view an antenna element 24 and a ground conductor 26 disposed in the interior space of the roof spoiler 18. The antenna element 24 is mounted on an element base 28. The element base 28 is fixed by means of screws to boss portions on an inner surface of the structural member 20. The ground conductor 26 is mounted on a ground base 30 and fixed to the structural member 20. The antenna element 24 and the ground conductor 26 are positioned next to each other. A joint 34, to which one end of a cable 32 is connected, is disposed between the antenna element 24 and the ground conductor 26. The joint 34 has a plate-like shape and is held by a grip portion 36 provided on the antenna element 24 and a grip portion 38 provided on the ground conductor 26. The cable 32 has the other end connected to a transmission/reception circuit (not illustrated) of the antenna apparatus. The transmission/reception circuit is electrically connected to the antenna element 24 and the ground conductor 26 via the cable 32 and the joint 34.

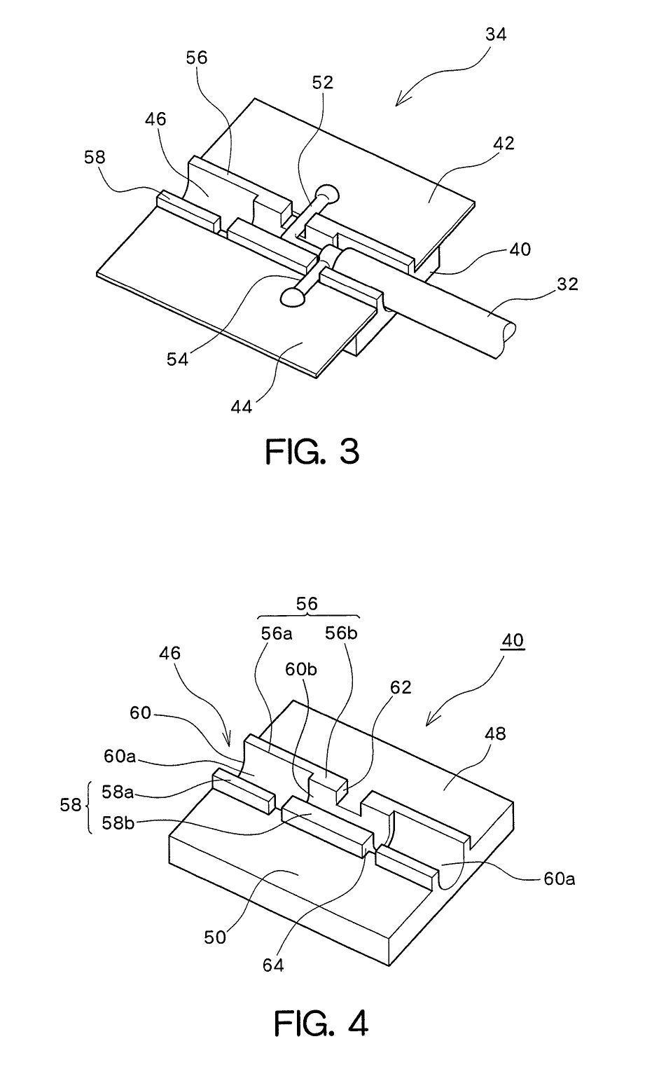

FIGS. 3 and 4 illustrate a detailed structure of the joint 34. The joint 34 includes a joint base 40, an element relay conductor 42 (a flat plate member) to be connected to the antenna element 24, and a ground relay conductor 44 (another flat plate member) to be connected to the ground conductor 26. The joint base 40 is made of an insulating material, such as insulating resin, which can securely insulate the relay conductors 42 and 44 from each other. The joint base 40 includes a cable fixing portion 46 and two relay conductor setup surfaces 48 and 50. The cable fixing portion 46 has a groove shape extending along the center line of the joint base 40. The relay conductor setup surfaces 48 and 50, positioned at both sides of the cable fixing portion 46, are substantially flat surfaces on which the relay conductors 42 and 44 are fixed. The cable 32 is a coaxial cable composed of an inner conductor (core wire) 52 and an external conductor (wire mesh) 54. The inner conductor 52 is bonded (soldered) onto the element relay conductor 42 and the external conductor 54 is bonded (soldered) onto the ground relay conductor 44.

The joint base 40 has a rectangular plate shape. The cable fixing portion 46 includes two walls 56 and 58 that define a cable holding groove 60 that can receive the cable 32. The first wall 56 has a height larger than that of the relay conductor setup surface 48. The first wall 56 can separate the element relay conductor 42 from the cable 32 when the cable 32 is placed in the cable holding groove 60. The second wall 58 has a height larger than that of the relay conductor setup surface 50. The second wall 58 can separate the ground relay conductor 44 from the cable 32 when the cable 32 is placed in the cable holding groove 60.

The cable holding groove 60 has two large-diameter portions 60a and a small-diameter portion 60b. Each large-diameter portion 60a, positioned near an edge of the joint 34, has a larger inner diameter. The small-diameter portion 60b, positioned at the center of the joint 34, has a small inner diameter. The first wall 56 has a thin portion 56a at a region corresponding to the large-diameter portion 60a and a thick portion 56b at a region corresponding to the small-diameter portion 60b (refer to FIG. 4). Similar to the first wall 56, the second wall 58 has a thin portion 58a and a thick portion 58b. The large-diameter portion 60a has an inner diameter corresponding to an outer diameter of the coaxial cable 32 so that the large-diameter portion 60a can hold the coaxial cable 32. The small-diameter portion 60b has an inner diameter corresponding to a diameter of the internal conductor 52 of the coaxial cable 32 so that the small-diameter portion 60b can hold the internal conductor 52.

The thick portion 56b of the first wall 56 has a first rectangular notch 62 capable of positioning the internal conductor 52 of the coaxial cable 32 so that the internal conductor 52 can extend toward the relay conductor setup surface 48. A second rectangular notch 64 capable of positioning the external conductor 54 of the coaxial cable 32 is formed at the boundary between the thin portion 58a and the thick portion 58b of the second wall 58. The external conductor 54, held by the second rectangular notch 64, extends toward the relay conductor setup surface 50. The first rectangular notch 62 is positioned at the center of the cable holding groove 60 in the longitudinal direction. The right and left halves of the cable holding groove 60 are symmetrical to each other.

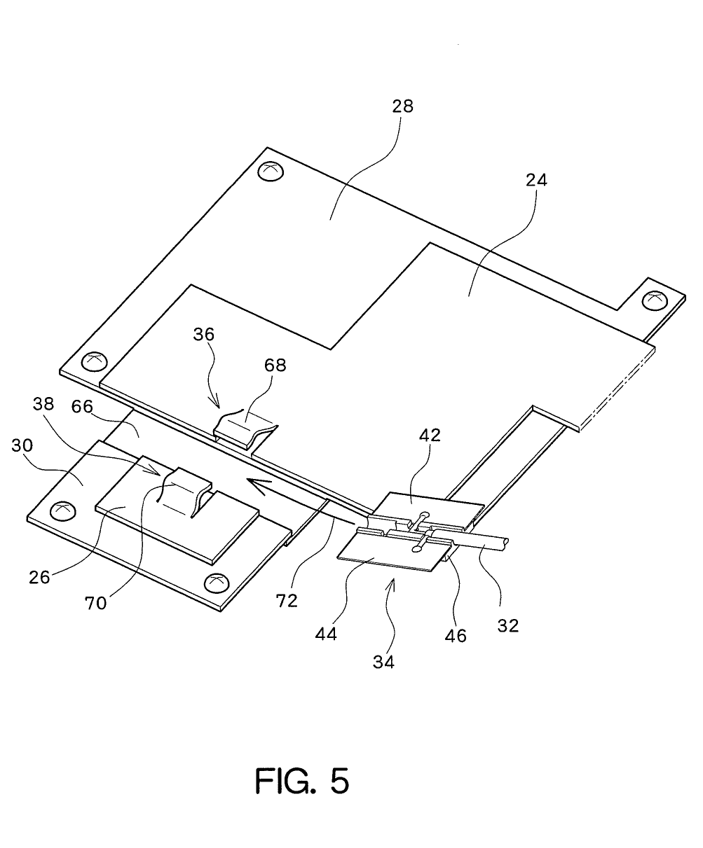

FIG. 5 illustrates a detailed structure of the antenna element 24 and the ground conductor 26 which are united. As described above, the antenna element 24 is fixed to the element base 28 by means of an adhesive and the ground conductor 26 is fixed to the ground base 30 by means of an adhesive. The element base 28 and the ground base 30 are united with a band 66. The grip portion 36 of the antenna element 24 and the grip portion 38 of the ground conductor 26 are in a mutually opposed relationship. An example method for forming the grip portions 36 and 38 includes cutting the edge of each plate member constituting the antenna element 24 and the ground conductor 26 to provide two parallel slits and bending (lifting) a portion dissected by two slits upward from the plate member to form spring plate portions 68 and 70. The spring plate portions 68 and 70 can grip both sides of the joint 34 (i.e., the element relay conductor 42 and the ground relay conductor 44). Each of the spring plate portions 68 and 70 has a guide at its distal end configured into a shape that can easily receive the joint 34. The spring plate portions 68 and 70 have elasticity sufficient for enabling the grip portions 36 and 38 to resiliently hold the relay conductors 42 and 44. The spring plate portion 68 of the antenna element 24 is brought into contact with the element relay conductor 42 when the joint 34 is engaged with the grip portion 36. The internal conductor 52 of the cable 32 is electrically connected to the antenna element 24.

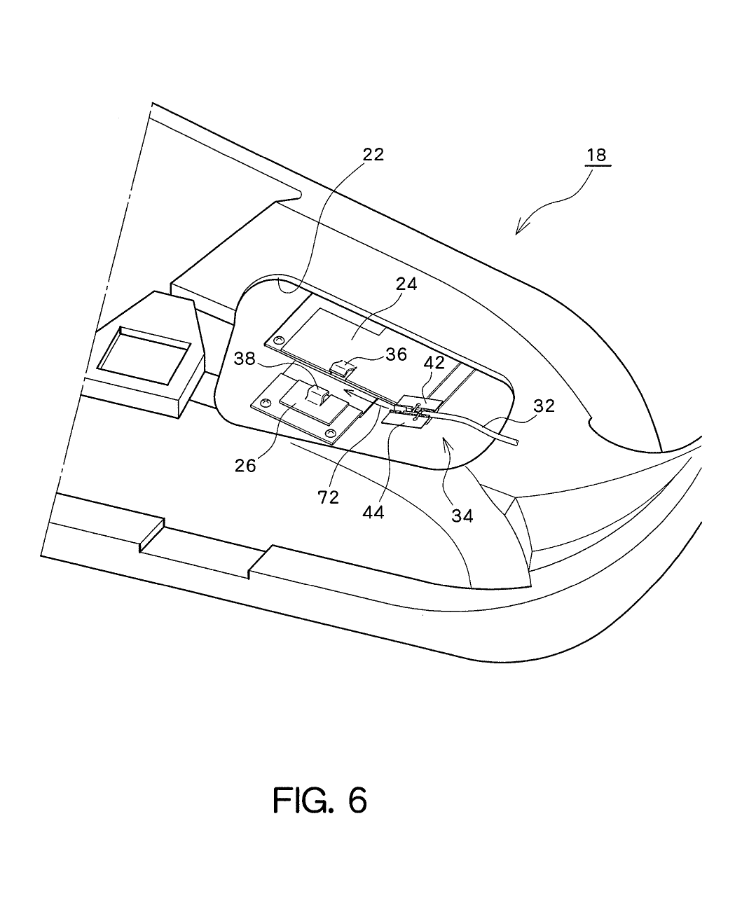

FIG. 6 is a perspective view illustrating an installation of the antenna apparatus which includes the antenna element 24, the ground conductor 26 and the cable 32. First, a worker puts the antenna element 24 and the ground conductor 26 into the interior space of the roof spoiler 18 via the opening 22 in a state where the antenna element 24 and the ground conductor 26 are fixed to the element base 28 and the ground base 30 which are united. The integrated assembly is fixed to a pre-designated position in the interior space of the roof spoiler 18 (as illustrated in FIG. 6). Subsequently, the worker puts the joint 34 integrated with the cable 32 into the interior space of the roof spoiler 18 and inserts the element relay conductor 42 and the ground relay conductor 44 of the joint 34 into the grip portions 36 and 38 of the antenna element 24 and the ground conductor 26 while sliding the joint 34 in the direction of an arrow 72 illustrated in FIG. 6. When the worker fully slides the joint 34, the cable 32 can be reliably engaged with the antenna element 24 and the ground conductor 26. According to the above-described installation method, workers can easily accomplish the installation work including disposing and fixing the antenna element 24 and the ground conductor 26 in the interior space of the roof spoiler 18, because the cable 32 is not attached to the antenna element 24.

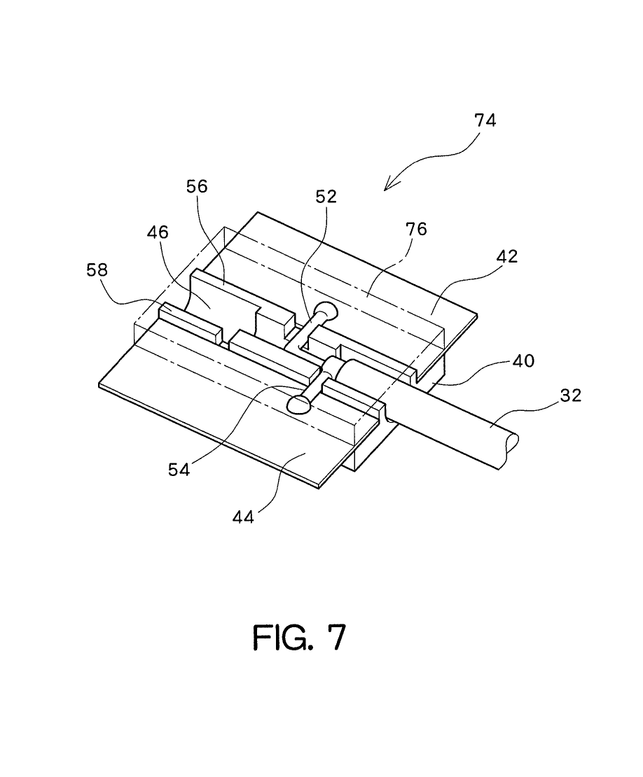

FIG. 7 illustrates another joint 74 which differs from the above-described joint 34 in that the upper surface of the joint is covered with a resin sealing member 76 possessing insulation properties. Components of the joint 74 are similar to those of the joint 34 and therefore FIG. 7 includes reference numerals used for the joint 34 in FIG. 3. The sealing member 76 is, for example, a hot melt that can assure waterproof properties when used for sealing a connecting point of the internal conductor 52 of the cable 32 and the element relay conductor 42 as well as an uncovered portion of the internal conductor 52. Similarly, the sealing member 76 can assure waterproof properties when used for sealing a connecting point of the external conductor 54 of the cable 32 and the ground relay conductor 44 as well as an uncovered portion of the external conductor 54.

What is claimed is:

1. An automotive antenna apparatus comprising:
an antenna element disposed in an interior space of an automotive exterior accessory;
a cable electrically connected to a transmission/reception circuit;
a first relay conductor electrically connected to a first conductor of the cable; and
a joint including the first relay conductor and a joint base holding the first relay conductor,
wherein the antenna element includes a grip portion configured to hold the joint and contact the first relay conductor of the joint, and the antenna element can be electrically connected to the cable when the grip portion is brought into contact with the first relay conductor.

2. The automotive antenna apparatus according to claim 1, further comprising a ground conductor disposed in the interior space of the automotive exterior accessory,
wherein the joint includes a second relay conductor insulated from the first relay conductor and held on the joint base,
the cable includes a second conductor integrated with the second relay conductor of the joint,
the ground conductor includes a grip portion configured to hold the joint and contact the second relay conductor, and
the ground conductor can be electrically connected to the cable when the grip portion of the ground conductor is brought into contact with the second relay conductor.

3. The automotive antenna apparatus according to claim 2, wherein the antenna element and the ground conductor are disposed next to each other and the joint is positioned between the antenna element and the ground conductor.

4. The automotive antenna apparatus according to claim 1, wherein a contact portion where the first conductor contacts the first relay conductor and an uncovered portion of the first conductor extending from the contact portion are sealed with an insulating material.

5. The automotive antenna apparatus according to claim 2, wherein an integrated insulating material seals a contact portion where the first conductor contacts the first relay conductor and an uncovered portion of the first conductor extending from the contact portion, and the integrated insulating material seals another contact portion where the second conductor contacts the second relay conductor and an uncovered portion of the second conductor extending from the connecting portion.

6. A cable connecting method for an automotive antenna apparatus, comprising the steps of:
disposing an antenna element with a grip portion into an interior space of an automotive exterior accessory; and
putting a joint including a relay conductor electrically connected to a conductor of a cable into the interior space of the automotive exterior accessory and engaging the joint with the grip portion of the antenna element disposed in the interior space of the automotive exterior accessory, thereby connecting the grip portion of the antenna element to the relay conductor.

7. A cable connecting method for an automotive antenna apparatus, comprising the steps of:
disposing an antenna element with a grip portion and a ground conductor with a grip portion into an interior space of an automotive exterior accessory; and
putting a joint including a first relay conductor electrically connected to a first conductor of a cable and a second relay conductor electrically connected to a second conductor of the cable into the interior space of the automotive exterior accessory, and engaging the joint with the grip portions of the antenna element and the ground conductor disposed in the interior space of the automotive exterior accessory, thereby bringing the grip portion of the antenna element into contact with the first relay conductor and bringing the grip portion of the ground conductor into contact with the second relay conductor.

8. The method according to claim 7, wherein the antenna element and the ground conductor are disposed next to each other so that the grip portions are opposed to each other and the joint is positioned between the opposed grip portions of the antenna element and the ground conductor.
